(19) United States
(12) Patent Application Publication
(10) Pub. No.: US 2009/0163359 A1
(43) Pub. Date: Jun. 25, 2009

(54) AMBIENT TEMPERATURE NITROGEN OXIDE ADSORBENT

(76) Inventors: Takaaki Kanazawa, Aichi-ken (JP); Akemi Sato, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/096,411

(22) PCT Filed: Nov. 28, 2006
(86) PCT No.: PCT/JP2006/324143

§ 371 Date: Jun. 6, 2008

(30) Foreign Application Priority Data
Dec. 12, 2005 (JP) 2005-357506

(51) Int. Cl. B01J 20/06

(52) U.S. Cl. 502/400

(57) ABSTRACT

Provided is an ambient temperature NOₓ adsorbent. The ambient temperature NOₓ adsorbent comprises a support and a metal supported on the support. The support comprises at least one metal oxide selected from oxides of Co, Fe, Cu, Ce, Mn, and a combination thereof. The supported metal comprises at least one metal selected from Cu, Co, Ag, Pd, and a combination thereof. The metal oxide is easily changed the oxidation number and has oxygen absorptive/emissive properties. The supported metal has an oxidative activity and is highly adsorptive to NO. Oxygen supplied from the metal oxide converts the supported metal to a peroxidized form of the supported metal. Hence, NO is readily adsorbed to the supported metal at ambient temperature around room temperature. The adsorbed NO is easily oxidized to NO₂ by oxygen supplied from the metal oxide or the supported metal in a peroxidized state in the absence of oxygen in an ambient atmosphere. The NO₂ is then efficiently adsorbed to the metal oxide. That is, the ambient temperature NOₓ adsorbent can adsorb a sufficient amount of NOₓ even at ambient temperature around room temperature.

### BACKGROUND OF THE INVENTION

1. Field of the Invention

The present invention relates to a NOₓ adsorbent that adsorbs NOₓ at ambient temperature in a range of room temperature. The NOₓ adsorbent suggested by various embodiments of the present invention is disposed upstream or downstream of an exhaust gas purifying catalyst, e.g., a three-way catalyst or a NOₓ adsorption/reduction catalyst, in an exhaust gas passage, so that the NOₓ adsorbent can adsorb a sufficient amount of NOₓ until the temperature of the exhaust gas purifying catalyst reaches a certain range of the activation temperature of the catalyst so as to greatly suppress the emission of the NOₓ to the atmosphere.

2. Description of the Related Art

Due to improvements in technology concerning exhaust gas purifying catalysts, including three-way catalysts and NOₓ adsorption/reduction catalysts, harmful substances contained in exhaust gases from automobiles are being gradually decreased to very low levels. However, since exhaust gas purifying catalysts are used to purify exhaust gases by oxidation or reduction of harmful substances contained in the exhaust gases by catalytic activities of catalytic metals (e.g., platinum (Pt)), they disadvantageously remain inactive at a temperature less than the activation temperature of the catalytic metals.

Specifically, harmful substances contained in exhaust gases are emitted without being purified for several tens of seconds until the temperature of an exhaust gas purifying catalyst is increased above the activation temperature of a catalytic metal immediately after start-up of an engine. In particular, during the winter time, the emission of unpurified harmful substances is often extensive for a long period of time.

The activation temperature of a catalytic metal, at which the catalytic activity of the catalytic metal takes place, varies depending on the kind of substances contained in exhaust gases to be purified. For example, the activation temperature of NOₓ, at which NOₓ can be purified, is higher than the activation temperatures of HC and CO, at which HC and CO can be purified. Accordingly, the emission time of NOₓ is longer than that of HC and CO.

Thus, it is contemplated that the emission of NOₓ to the atmosphere can be suppressed by adsorbing NOₓ until the temperature of an exhaust gas purifying catalyst is increased above the activation temperature of a catalytic metal immediately after start-up of an engine.

For example, Japanese Unexamined Patent Publication No. 2001-198455 teaches a NOₓ adsorbent which comprises one metal oxide selected from oxides of Co, Fe and Ni. The NOₓ adsorbent adsorbs a large amount of NOₓ in a low-temperature region below 400C. The NOₓ adsorbent shows a saturated adsorption amount of NOₓ of 10×10⁻⁵ mol/g or more in gases at 40° C. or lower, and has good NOₓ adsorption performance at low temperature.

Further, Japanese Unexamined Patent Publication No. 2001-289035 describes a NOₓ adsorbent comprising an alkali metal oxide, alkaline earth metal oxide, CO₃O₄, NiO₂, MnO₂, Fe₂O₃, ZrO₂, and zeolite. This patent publication describes that the NOₓ adsorbent can adsorb NOₓ contained in exhaust gases usually in low to intermediate temperature regions.

However, these NOₓ adsorbents may have a low adsorptivity for NOₓ at ambient temperature in a range of room temperature, and have limitations in that NOₓ is emitted to the atmosphere until the temperature of an exhaust gas purifying catalyst reaches the activation temperature of a catalytic metal.

### SUMMARY OF THE INVENTION

The present invention has been made in view of the above limitations, and is directed to provide a NOₓ adsorbent capable of adsorbing a sufficient amount of NOₓ even at ambient temperature in a range of room temperature.

In accordance with an aspect of the present invention, there is provided an ambient temperature NOₓ adsorbent comprising a support and a metal supported on the support (hereinafter, referred to simply as a ‘supported metal’) wherein the support comprises at least one metal oxide selected from oxides of Co, Fe, Cu, Ce, Mn, and a combination thereof (hereinafter, referred to simply as a ‘selected metal oxide’) and the supported metal comprises at least one metal selected from Cu, Co, Ag, Pd, and a combination thereof with the condition that the support includes the metal different from the supported metal.

In one embodiment, the supported metal can be one metal selected from Ag and Pd.

In one embodiment, the selected metal oxide can be selected from oxides of Co, Fe, Ce, and a combination thereof.

In one embodiment, the supported metal is supported in an amount of about 1 to 20 parts by weight with respect to 100 parts by weight of the selected metal oxide.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an explanatory diagram illustrating the NOₓ adsorption mechanism of a NOₓ adsorbent according to an embodiment of the present invention;

FIG. 2 is a graph showing the amounts of NO adsorbed by various NOₓ adsorbents prepared in Examples and Comparative Examples;

FIG. 3 illustrates X-ray photoelectron spectroscopic (XPS) spectra of Test Example 1; and

FIG. 4 illustrates Fourier transform infrared (FT-IR) spectroscopic spectra of Test Example 2.

### DESCRIPTION OF SPECIFIC EMBODIMENTS

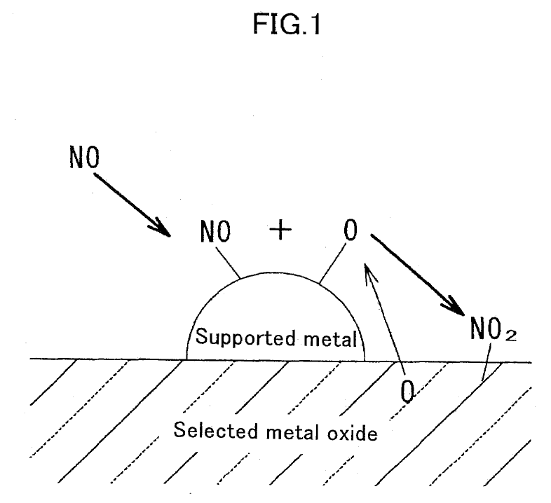

The oxidation number of at least one metal oxide selected from oxides of Co, Fe, Cu, Ce, Mn, and a combination thereof is easily changed and has oxygen absorptive/emissive properties. At least one supported metal selected from Cu, Co, Ag, Pd, and a combination thereof has an oxidative activity and is highly adsorptive to NO. The supported metal is converted to its peroxidized form by oxygen supplied from the selected metal oxide. Accordingly, as shown in FIG. 1, NO present in an atmosphere is adsorbed to the supported metal even at ambient temperature, which is in a range of room temperature. The adsorbed NO is readily oxidized to NO₂ by oxygen supplied from the selected metal oxide or the supported metal in a peroxidized state even in the absence of oxygen in an ambient atmosphere. The NO₂ is then efficiently adsorbed to the selected metal oxide.

Accordingly, the ambient temperature NOₓ adsorbent according to the embodiment of the present invention can adsorb NO present in an atmosphere in a very efficient manner, and can considerably suppress the emission of NOₓ until the temperature of an exhaust gas purifying catalyst reaches a certain range of the activation temperature of a catalytic metal after start-up of an engine.

The ambient temperature NOₓ adsorbent comprises a support containing a selected metal oxide and a supported metal supported on the selected metal oxide. The selected metal oxide includes at least one metal oxide selected from oxides of Co, Fe, Cu, Ce, Mn, and a combination thereof. Particularly, at least one metal oxide selected from oxides of Co, Fe, Ce, and a combination thereof exhibits very high NOₓ adsorption performance due to its ease of changeability of the oxidation number and high oxygen emissive power.

Although the support includes the selected metal oxide only in the preset embodiment, the support may further contain another oxide selected from alumina, zirconia, titania, silica, zeolite, and other oxides. Since the amount of NOₓ adsorbed per unit volume is decreased with increasing amount of the other oxide, the amount of the other oxide is preferably as small as possible.

The supported metal includes at least one metal selected from Cu, Co, Ag, Pd, and a combination thereof, and is different from the metal composing the selected metal oxide. As the supported metal, particularly preferred is Pd or Ag. Pd or Ag is highly oxidative to NO. Particularly, Pd is much highly oxidative to NO than others because it is likely to be converted to a highly peroxidized form. Ag is believed to have high affinity to NO. Accordingly, the use of either Pd or Ag as the supported metal is advantageous in terms of improvement in NOₓ adsorption performance.

The supported metal is required to be supported on the selected metal oxide. In the case where an oxide other than the selected metal oxide is contained in the support, the supported metal may be supported on the additional oxide.

The supported metal is preferably supported in an amount of about 1 to 20 parts by weight with respect to 100 parts by weight of the selected metal oxide. If the supported metal is supported in an amount of less than 1 part by weight, the NOₓ adsorption performance of the adsorbent according to the present embodiment is likely to be reduced to a level similar to that of the conventional NOₓ adsorbent. Meanwhile, since the NOₓ adsorption performance of the adsorbent according to the present embodiment is usually saturated in an amount of 20 parts by weight of the supported metal, the addition of the supported metal in an amount exceeding 20 parts by weight may result in a plateau of the NOₓ adsorption performance.

The support of the supported metal on the selected metal oxide is achieved by dissolving a compound containing the supported metal in a certain solution, impregnating the selected metal oxide with a predetermined amount of the resultant solution, and calcining the impregnated metal oxide. Alternatively, the supported metal may be supported on the selected metal oxide by co-precipitating an aqueous solution of a nitrate of the supported metal and a nitrate of the compositional metal of the selected metal oxide to prepare an oxide precursor, and calcining the oxide precursor.

The NOₓ adsorbent according to the embodiment of the present invention can be disposed upstream or downstream of an exhaust gas purifying catalyst, e.g., a three-way catalyst or a NOₓ adsorption/reduction catalyst, in an exhaust gas passage. For example, if the NOₓ adsorbent comprises CeO₂ as a support and Pd as a supported metal, NOₓ begins to separate from the NOₓ adsorbent at around 300° C. and all NOₓ are emitted at a temperature of about 500° C. or higher. Accordingly, when the NOₓ adsorbent is disposed upstream of an exhaust gas purifying catalyst in an exhaust gas passage, NOₓ is emitted from the NOₓ adsorbent at a temperature (300° C. or higher) of exhaust gases, introduced into the exhaust gas purifying catalyst, which is already heated above the activation temperature of the catalyst, and purified by the exhaust gas purifying catalyst.

On the other hand, when the NOₓ adsorbent is disposed downstream of an exhaust gas purifying catalyst, NOₓ emitted from the NOₓ adsorbent after the temperature of exhaust gases reaches about 300° C. or higher is preferably returned upstream of the exhaust gas purifying catalyst, and purified by the exhaust gas purifying catalyst.

### EXAMPLES

Hereinafter, the present invention will be explained in detail with reference to the following examples, including comparative examples and test examples.

### Example 1

A Fe₂O₃ powder was impregnated with a predetermined amount of an aqueous solution of palladium nitrate having a given concentration, evaporated to dryness at about 120° C. for about 2 hours, and calcined at about 500° C. for about 2 hours to prepare a NOₓ adsorbent powder. In the present experimental embodiment of the present invention, an amount of the Pd supported on the Fe₂O₃ powder was about 5% by weight.

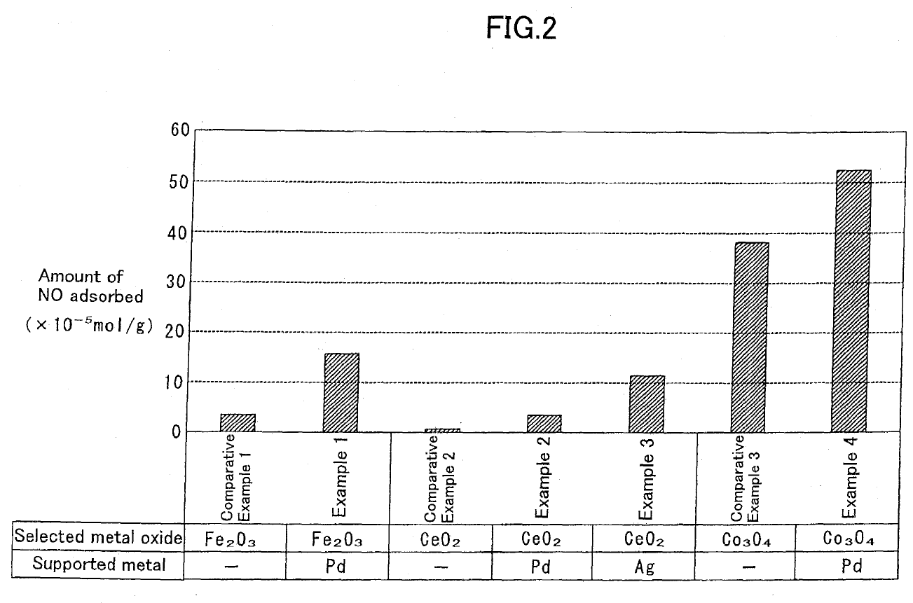

The NOₓ adsorbent powder was pelletized by a prescribed process, and then a specified amount of the pellets was filled in an evaluation device. After N₂ gas containing about 100 ppm NO was circulated at room temperature for about 8 minutes, the amount of the NO adsorbed to the NOₓ adsorbent powder was measured using a system for analysis of exhaust gases from automobiles. The results are shown in FIG. 2.

### Comparative Example 1

Substantially the same procedure described in Example 1 was performed, with one difference in that only the Fe₂O₃ powder (NO Pd) was pelletized by a prescribed process. The results are shown in FIG. 2.

### Example 2

A NOₓ adsorbent powder was prepared substantially in the same manner as in Example 1 with one difference in that a CeO₂ powder was used instead of the Fe₂O₃ powder. The amount of NO adsorbed to the NOₓ adsorbent powder was measured in accordance with the procedure described in Example 1. The results are shown in FIG. 2.

### Example 3

A NOₓ adsorbent powder was prepared substantially in the same manner as in Example 1 with two differences in that a CeO₂ powder was used instead of the Fe₂O₃ powder, and an aqueous solution of silver nitrate was used instead of the aqueous solution of palladium nitrate. The Ag supported on the CeO₂ powder had an amount of about 5% by weight. The amount of NO adsorbed to the NOₓ adsorbent powder was measured in accordance with the procedure described in Example 1. The results are shown in FIG. 2.

### Comparative Example 2

Substantially the same procedure described in Example 1 was performed, with one difference in that only the CeO₂ powder (NO Pd) used in Example 2 was pelletized by a prescribed process. The results are shown in FIG. 2.

### Example 4

A NOₓ adsorbent powder was prepared substantially in the same manner as in Example 1 with one difference in that a CO₃O₄ powder was used instead of the Fe₂O₃ powder. The amount of NO adsorbed to the NOₓ adsorbent powder was measured in accordance with the procedure described in Example 1. The results are shown in FIG. 2.

### Comparative Example 3

Substantially the same procedure described in Example 1 was performed with one difference in that only the CO₃O₄ powder (NO Ag) used in Example 4 was pelletized by a prescribed process. The results are shown in FIG. 2.

### <Evaluation>

As is evident from the graph of FIG. 2, the support of Pd or Ag on each of the selected metal oxide powders resulted in an increase in the amount of NO adsorbed to each of the NOₓ adsorbents. That is, the NOₓ adsorbents prepared in Examples 1 to 4 showed greatly improved NOₓ adsorption performance at room temperature, compared to the NOₓ adsorbents prepared in Comparative Examples 1 to 3.

### Test Example 1

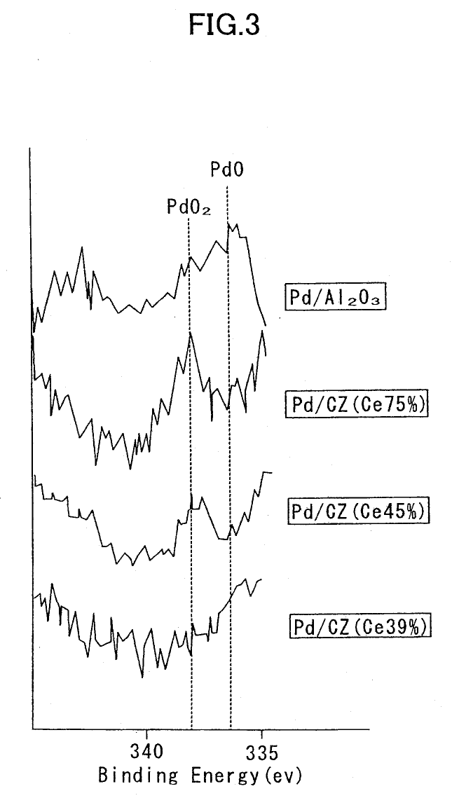

Three CeO₂—ZrO₂ composite oxide powders having different Ce-to-Zr molar ratios of about 0.75, 0.45 and 0.39, and an Al₂O₃ powder were prepared, and then about 5% by weight of Pd was supported thereon in accordance with the procedure described in Example 1. The state of the Pd supported on the oxide metal powders was observed by XPS. The results are shown in FIG. 3. The CeO₂—ZrO₂ composite oxide was abbreviated as “CZ” in FIG. 3.

The graph of FIG. 3 shows that the higher the content of the CeO₂, the higher the peak corresponding to PdO₂ bonds. The graph also shows that the lower the content of the CeO₂, the higher the peak corresponding to arising from PdO bonds. These results reveal that the Pd supported on the CeO₂ was present in a tetravalent peroxidized form (PdO₂) and had an extremely high oxidative activity. The amount of Pd present in a peroxidized form increased with increasing content of the CeO₂. Accordingly, it is apparent that the Pd captured oxygen supplied from the CeO₂.

### Test Example 2

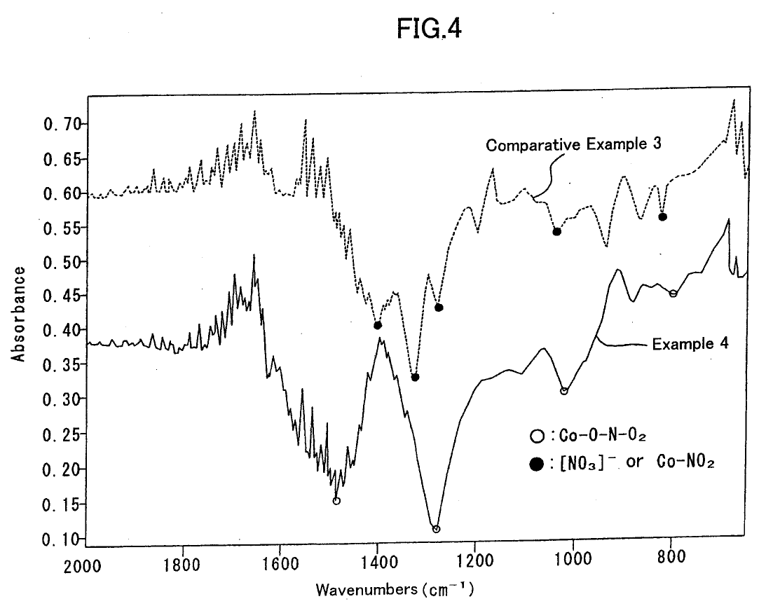

FT-IR spectra of the NOₓ adsorbents prepared in Example 4 and Comparative Example 3 were taken after adsorption of NO to the NOₓ adsorbents in accordance with the procedure described in Example 1. The spectra are shown in FIG. 4.

Major peaks observed in the spectrum of the NOₓ adsorbent prepared in Comparative Example 3 were absorption peaks (about 1400 cm⁻¹, 1040±20 cm⁻¹ and 825 cm⁻¹) corresponding to the presence of NO₃⁻ free ions, absorption peaks (about 1410±10 cm⁻¹, 1340±10 cm⁻¹ and 835±10 cm⁻¹) corresponding to Co—NO₂ bonds, and absorption peaks (about 1330 cm⁻¹, 1260 cm⁻¹ and 830 cm⁻¹) corresponding to the presence of ONO⁻ free ions.

On the other hand, major peaks observed in the NOₓ adsorbent prepared in Example 4 were absorption peaks (about 1490±10 cm⁻¹, 1280±10 cm⁻¹, 1010 cm⁻¹ and 800 cm⁻¹) corresponding to Co—O—NO₂ bonds.

In conclusion, the state of NO adsorbed to each of the NOₓ adsorbents varies according to whether or not Pd is supported on each of the metal oxides. The observation of the absorption peak corresponding to Co—O—NO₂ bonds in the NOₓ adsorbent prepared in Example 4 indicates that NO was oxidized to NO₂, which was subsequently adsorbed to the metal oxide even in the absence of oxygen.

On the basis of the results of Test Example 1, the Pd was converted to a peroxidized form (i.e. PdO₂) by capturing oxygen from the CO₃O₄. NO was oxidized to NO₂ by capturing the oxygen from the Pd which is in a peroxidized form, and then the NO₂ was adsorbed to the NOₓ adsorbent. This NOₓ adsorption mechanism of the NOₓ adsorbent is illustrated in FIG. 1.

While the present invention has been described with respect to the specific embodiments, it will be apparent to those skilled in the art that various changes and modifications may be made without departing from the spirit and scope of the invention as defined in the following claims.

1. An ambient temperature NOₓ adsorbent adsorbing NOₓ at ambient temperature in a certain range of room temperature; the NOₓ adsorbent comprising:
a support; and
a metal supported on the support,
wherein the support comprises at least one metal oxide selected from oxides of Co, Fe, Cu, Ce, Mn, and a combination thereof; and the supported metal comprises at least one metal selected from Cu, Co, Ag, Pd, and a combination thereof, with the condition that the support comprises the metal different from the supported metal.

2. The NOₓ adsorbent according to claim 1, wherein the supported metal comprises one of Ag and Pd.

3. The NOₓ adsorbent according to claim 1 or 2, wherein the metal oxide is selected from oxides of Co, Fe, Ce, and a combination thereof.

4. The NOₓ adsorbent according to claim 1 or 2, wherein the supported metal is supported in an amount of about 1 to 20 parts by weight with respect to 100 parts by weight of the metal oxide.
